(19) United States
(12) Patent Application Publication
(10) Pub. No.: US 2025/0250739 A1
(43) Pub. Date: Aug. 7, 2025

(54) A MACHINE FOR PRODUCING A FIBROUS WEB

(71) Applicant: VALMET AB, Sundsvall (SE)

(72) Inventors: Bruno TREMBLAY, Sherbrooke (CA); Mikhail SHEKHTER, South Portland, ME (US); Kimberly DOWNING, South Portland, ME (US); Mark RIVARD, Thunder Bay (CA)

(21) Appl. No.: 18/856,746

(22) PCT Filed: May 22, 2023
(86) PCT No.: PCT/EP2023/063659

§ 371 Date: Oct. 14, 2024

(30) Foreign Application Priority Data
Jun. 1, 2022 (SE) 2230174-1

(51) Int. Cl. D21F 5/18; D21F 5/20; D21F 11/14

(52) U.S. Cl. CPC D21F 5/181; D21F 5/20; D21F 11/14

(57) ABSTRACT

Embodiments of the invention involve a machine (1) for producing a fibrous web, such as for tissue, for example paper tissue, the machine comprising a forming section (2) and a drying section (4, 5), wherein the machine is adapted to form a stream of combined air by combining exhaust streams from the forming section (2) and the drying section (4, 5), and to guide the stream of combined air to a combined air heat exchanger (7) adapted to transfer heat from the combined air to a fluid combined air to a fluid.

### TECHNICAL FIELD

The invention relates to a machine for producing a fibrous web, such as for tissue, for example paper tissue. The machine could alternatively be a paper machine, or a board machine.

### BACKGROUND

Efforts are being made to reduce the energy consumption in connection to the use of machines for producing fibrous webs for tissue or paper. This may involve recovering heat generated by such machines. For example, U.S. Pat. No. 11,118,311 describes a papermaking process with the steps of forming a wet paper web on a papermaking machine, pulling vacuum by centrifugal blowers through the web to remove water from the web and thereby generate discharge air, and diverting at least a portion of the discharge air through a control loop to a hot air drying system within the papermaking process to aid in drying the web.

WO9856986A1 discloses an arrangement for recovering heat from exhaust air in the vacuum system of a paper, cardboard or pulp machine. Exhaust air flows discharged by different vacuum fans are made to travel through different heat exchanger cells of a heat recovery tower, as parallel flows so that they do not substantially mix with each other.

However, some heat recovery arrangements increase the complexity, and therefore the capital cost, of the machines. Therefore, there is also a desire to, while reducing the energy consumption in connection to the use of machines for producing fibrous webs, avoiding a large increase of the complexity of the machines.

### SUMMARY

An object of the invention is to reduce the energy consumption in connection to the use of machines for producing fibrous webs, while avoiding a large increase of the complexity of the machines.

The object is reached with an aspect of the invention involving a machine for producing a fibrous web, such as for tissue, for example paper tissue, the machine comprising a plurality of sections adapted to provide respective steps of the web production, the machine being adapted to sequentially pass material for the fibrous web through the sections, the machine being adapted to provide two or more exhaust streams from respective ones of the sections. The machine is adapted to form a stream of combined air by combining two or more exhaust streams of the exhaust streams, and to guide the stream of combined air to a combined air heat exchanger adapted to transfer heat from the combined air to a fluid.

For example, the machine may be adapted to provide a first stream of exhaust air from a first section of the sections, and a second stream of exhaust air from a second section of the sections, which second section is different from the first section. Thereby, the machine may be adapted to form the stream of combined air by combining the first and second streams of exhaust air.

Each section may comprise at least one carrier for the web, e.g. in the form of a fabric or a drum. The carrier(s) of any section is preferably different from the carrier(s) of any other section.

The machine may comprise what is herein referred to as a combined air heat exchanger. By the machine being adapted to form a stream of combined air by combining two or more exhaust streams of the exhaust streams, and to guide the stream of combined air to a combined air heat exchanger adapted to transfer heat from the combined air to a fluid, the combined air heat exchanger can be used for extracting heat from two streams, originating from different sections of the machine. Thus, a single heat exchanger may be used to extract excess heat from two sections. This will contribute to keeping the complexity of the machine, and thus the capital cost of the machine, relatively low.

In addition, the invention provides energy savings compared to known heat recovery methods. For example, in said known process of U.S. Pat. No. 11,118,311, the discharge air which is diverted into the hot air drying system, will increase the air mass in the hot air drying system. This will increase the fan requirements, and therefore the electrical consumption, of that system. With the heat recovery according to the invention, such an air mass increase, and the entailing increase in electrical consumption, can be avoided.

In said aspect of the invention, the plurality of sections comprises a forming section adapted to form the web from a furnish. The forming section comprises an air moving arrangement, with an inlet and an exhaust, arranged to provide a pressure gradient across the web being formed in the forming section in order to move air through the web being formed in order to remove water from the web being formed. Thereby, the two or more exhaust streams that the machine is adapted to combine to form the stream of combined air comprises a stream of air from the exhaust of the air moving arrangement.

The forming section may comprise a carrier for the web. The carrier may be in the form of a permeable sheet, e.g. in the form if a mesh, e.g. a wire mesh. Along the path of the stream of air which is moved through the web being formed, the air moving arrangement is preferably located downstream of the web being formed. The air moving arrangement may be for example a vacuum blower. The stream of air that is moved through the web being formed may be pre-heated. However, in some embodiments, the stream of air is not heated before passing through the web. In any case, the air may be heated by compression in the air moving arrangement. Thereby, the air can reach e.g. 125-170° C.

In said aspect of the invention, the plurality of sections comprises a drying section adapted to subject the web formed by the forming section to a drying process in order to dry the web formed by the forming section. Thereby, the two or more exhaust streams that the machine is adapted to combine to form the stream of combined air comprises a stream of air with residual heat from the drying process. The air with residual heat from the drying process may be air from the drying process, with residual heat. The air with residual heat from the drying process may be exhaust air from the drying process.

Thus, in said aspect of the invention, a first of the sections is a forming section, a second of the sections is a drying section. Thereby, the machine is adapted to form the stream of combined air by combining the stream of air from the exhaust of the air moving arrangement and the stream of air with residual heat from the drying process. Thereby, the combined air heat exchanger can be used for extracting heat from the air moving arrangement exhaust stream and the stream of air with residual heat of from the drying process.

By the machine according to said aspect of the invention, a single heat exchanger can be used for extracting excess heat from the forming section as well as from the drying section. This will contribute to reducing the complexity of the machine, and thus the capital cost of the machine. Also, the mixture of air from the forming section and from the drying section will carry the combined energy of the two streams, and this will increase the energy available for one or more heat receiving fluids of the heat exchanger.

The stream of air from the exhaust of the air moving arrangement may be guided towards the combined air heat exchanger through a forming exhaust conduit. The machine is preferably arranged to guide the stream of air with residual heat from the drying process through a drying exhaust conduit towards the combined air heat exchanger. The forming exhaust conduit may be joined with the drying exhaust conduit to form a combined air conduit. The combined air conduit may extend from a location where the stream of combined air is formed.

In some embodiments, a drying exhaust fan is provided in the drying exhaust conduit. Thereby, the machine is preferably arranged to guide the stream of air from the exhaust of the air moving arrangement into the drying exhaust conduit, downstream of the drying exhaust fan.

Alternatively, the machine is arranged guide the stream of air from the exhaust of the air moving arrangement into the drying exhaust conduit, upstream of the drying exhaust fan.

Preferably, the drying section comprises a through air drying (TAD) section. The TAD section may comprise a TAD cylinder with a peripheral structure having a plurality of openings. The TAD section may further comprise a TAD fabric forming by means of a plurality of rollers an endless loop which partially extends around the TAD cylinder. Thereby, the TAD section may be arranged to establish a pressure difference externally and internally of the TAD cylinder, so that air is drawn through the web, the TAD fabric, and the peripheral structure of the TAD cylinder to form a stream of TAD exhaust air. Thereby, the machine is preferably arranged to guide at least some of the TAD exhaust air in the stream of TAD exhaust air to form one of the two or more exhaust streams that the machine is adapted to combine to form the stream of combined air.

The TAD section may form at least a portion of a drying section described above. Thus, in some embodiments, a first of the sections is a forming section, a second of the sections is a TAD section. Thus, the machine may be arranged to guide at least some of the TAD exhaust air in the stream of TAD exhaust air to form at least a part of the stream of air with residual heat from the drying process to be combined with the stream of air from the exhaust of the air moving arrangement. Thereby, the combined air heat exchanger can be used for extracting heat from the air moving arrangement exhaust stream and from at least some of the TAD exhaust air.

The air that is drawn through the web, the TAD fabric, and the peripheral structure of the TAD cylinder, may be pre-heated, e.g. in a TAD air system. Such a TAD air system may circulate the air from the TAD cylinder to a TAD hood which at least partly surrounds the TAD cylinder. This circulation may include at least a part of said stream of TAD exhaust air. Thereby, the air may be heated by a heater. Also, air may be added to the recirculated air. For example, the heater may be a burner fed by added air and fuel.

In some embodiments, the drying section comprises a yankee dryer section comprising a yankee dryer. Thereby, the two or more exhaust streams that the machine is adapted to combine to form the stream of combined air comprises a yankee hood exhaust stream from a hood of the yankee dryer. The yankee hood exhaust stream may have residual heat from the yankee drying process.

Where the machine comprises a TAD section, the yankee dryer section may be located downstream of the TAD section, along the path of the web through the machine.

The yankee section may form at least a portion of a drying section described above. The yankee hood exhaust stream may form at least a part of a second stream of exhaust air to be combined with a first stream of exhaust air from a first of the sections, to form the combined air to be guided to the combined air heat exchanger. For example, the yankee hood exhaust stream may be combined with the air moving arrangement exhaust stream of a forming section, to form the combined air. In addition, or alternatively, the yankee hood exhaust stream may be combined with at least some of the TAD exhaust air from a TAD section.

Thus, in some embodiments, the yankee hood exhaust stream, at least some of a stream of TAD exhaust air, and an air moving arrangement exhaust stream from a forming section, may be combined and guided to the combined air heat exchanger. Thereby, the yankee hood exhaust stream may be combined with the stream of at least some of the TAD exhaust air, before the combined TAD exhaust air stream and yankee hood exhaust air stream are combined with the air moving arrangement exhaust stream.

In some embodiments, a yankee air system circulates air from the hood of the yankee dryer, via a yankee circulation conduit to be heated, and back to the hood. Thereby, some of the circulation air may be guided to form the yankee hood exhaust stream which is combined with the exhaust stream from the forming section, and guided to the combined air heat exchanger. In other embodiments, the yankee hood exhaust stream is guided directly from the hood of the yankee dryer.

As suggested, the yankee hood exhaust stream, and at least some of the stream of TAD exhaust air, may be combined and guided to the combined air heat exchanger. In such embodiments, there may be, or there may not be, an air moving arrangement exhaust stream guided to the combined air heat exchanger.

Thus, a first of the sections may be a TAD section. Thereby, the machine may be arranged to guide at least some of the TAD exhaust air in the stream of TAD exhaust air to form at least a part of a first stream of exhaust air as a stream of air with residual heat. Thereby, a second of the sections may be a yankee dryer section, wherein the machine is arranged to form at least a part of a second stream of exhaust air by a yankee hood exhaust stream from a hood of the yankee dryer.

Where the two or more exhaust streams that the machine is adapted to combine comprises a yankee hood exhaust stream, preferably the machine is arranged to guide air in the yankee hood exhaust stream to a yankee heat exchanger, and to guide the air in the yankee hood exhaust stream from the yankee heat exchanger to form a part of the combined airstream. In some embodiments, the machine is adapted so that upstream of yankee heat exchanger, the yankee hood exhaust stream is combined with an air moving arrangement exhaust stream from a forming section.

The combined air heat exchanger may be an air-to-liquid heat exchanger. The liquid to which the combined air heat exchanger transfers heat may be water, glycol, or a mix of two or more liquids such as water and glycol. Alternatively, the combined air heat exchanger is an air-to-air heat exchanger. Thereby, the fluid to which the combined air heat exchanger transfers heat may be air.

In some embodiments, the machine is arranged to deliver the fluid to which heat from the stream of combined air has been transferred, to a heating system which is separate from the machine. Thereby, the heating system may be a water heating system, e.g. for process water, white water, or fresh water, or for building heating or ceiling heat. Alternatively, the machine is arranged to deliver the fluid to which heat from the stream of combined air has been transferred, to a part of the machine. Thereby, the heat from the combined air heat exchanger may be used in the machine itself.

In some embodiments, the combined air heat exchanger is a first heat exchanger and the fluid is a first fluid, wherein the machine comprises a second heat exchanger arranged in parallel with the first heat exchanger and adapted to receive at least a portion of the stream of combined air and to transfer heat from the combined air to a second fluid. A forming exhaust conduit, leading from the forming section, may be joined with a drying exhaust conduit, leading from the drying section, to form a combined air conduit. The combined air conduit may be arranged to guide the combined air from a location where the stream of combined air is formed. The combined air conduit may be arranged to guide the combined air to the first heat exchanger. A branch conduit may be provided to guide at least a portion of the combined air to the second heat exchanger.

Preferably, the machine is adapted to selectively guide the stream of combined air to the first heat exchanger or the second heat exchanger. The selectivity can be provided with one or more dampers. Thereby, by suitable control of the one or more dampers, the stream of combined air can be divided into two or more sub-streams, each guided to a respective heat exchanger, including the first and second heat exchangers. Also, by suitable control of the one or more dampers, the stream of combined air can be guided to one or more of the heat exchangers, but less than all heat exchangers. Each heat exchanger may be adapted to transfer heat to a respective heat receiving fluid, e.g. water. The fluids may form parts of respective heating system for various uses, in the machine and/or separate from the machine. The multiple parallel heat exchangers arranged to selectively receive the combined air provide for a flexibility of the use of the heat in the combined air. Further, the heat exchangers may be optimized for individual process heating requirements of the respective system that they serve. Meanwhile, combining the air streams from the drying and forming sections allows an increase of the total available energy and for an optimized design of the heat exchanger combination including the first and second heat exchangers. Thereby, a good control of heat transfer to multiple heat absorption streams may be provided, e.g. in a single heat exchanger tower. In particular, if the heat receiving fluids are water or water based, the routing and control, including by-passing, becomes easy to implement in practice.

Preferably, where the machine comprises a combined air conduit arranged to guide the combined air from a location where the stream of combined air is formed, to the combined air heat exchanger, the length of the combined air conduit along the path of the combined air is at least 1.0 times the hydraulic diameter, preferably at least 1.5 times the hydraulic diameter, e.g. at least 2.0 times the hydraulic diameter, of the combined air conduit or a part of the combined air conduit with the smallest cross-sectional area. It is understood that the location where the stream of combined air is formed is upstream of the combined air heat exchanger. In some embodiments, the combined air conduit has a constant cross-sectional area, and in other embodiments, the cross-sectional area of the combined air conduit changes along its path, e.g. where there is a branch line leading from the combined air conduit.

Thus, the extension, or path, of the combined air conduit, from the location where the stream of combined air is formed, to the combined air heat exchanger, is at least 1.0 times the hydraulic diameter, preferably at least 1.5 times the hydraulic diameter, e.g. at least 2.0 times the hydraulic diameter, of the combined air conduit or a part of the combined air conduit with the smallest cross-sectional area. The hydraulic diameter, also referred to as the hydraulic duct diameter, or the hydraulic pipe diameter, can be calculated with the equation dh=4 A/p, where dh=the hydraulic diameter (m, ft), A=cross-sectional area of the duct or pipe (m2, ft2), p=wetted perimeter of the duct or pipe (m, ft). Thereby, the combined air conduit may be long enough to allow the air streams from the separate sections of the machine to mix before reaching the heat exchanger. Nevertheless, in some embodiments a mixing enhancement device can be provided in the combined air conduit.

Preferably, no heat exchanger is provided in a combined air conduit arranged to guide the combined air from a location where the stream of combined air is formed, to the combined air heat exchanger. Thereby it can be ensured that any heat exchange is provided only once the streams of air from the different machine sections are mixed.

Further aspects of the invention provide machines according to claims 14 and 15. Advantages with such machines are understood from the discussion above. In such a machine, air streams from a forming section and a drying section of the machine may be combined and guided to the combined air heat exchanger. Alternatively, air streams only from different locations of a forming section of the machine may be combined. In other alternatives, air streams only from different parts of a drying section of the machine may be combined. The machines according to claims 14 and 15 may involve features of any embodiment of any aspect of the invention.

Aspects of the invention also provides a combined air heat exchanger according to claim 16.

### DESCRIPTION OF THE DRAWINGS

Below embodiments of the invention will be described with reference to the drawings, in which

FIG. 1 shows schematically a machine for producing a fibrous web,

FIG. 2 shows a part of the machine in FIG. 1,

FIG. 3 shows a part of a machine for producing a fibrous web, according to an alternative embodiment of the invention,

FIG. 4 shows a part of a machine for producing a fibrous web, according to a further embodiment of the invention,

FIG. 5 shows a part of a machine for producing a fibrous web, according to another embodiment of the invention,

FIG. 6 shows a part of a machine according to yet another embodiment of the invention, and

FIG. 7 shows a part of a machine for producing a fibrous web, according to a further embodiment of the invention.

### DETAILED DESCRIPTION OF EMBODIMENTS

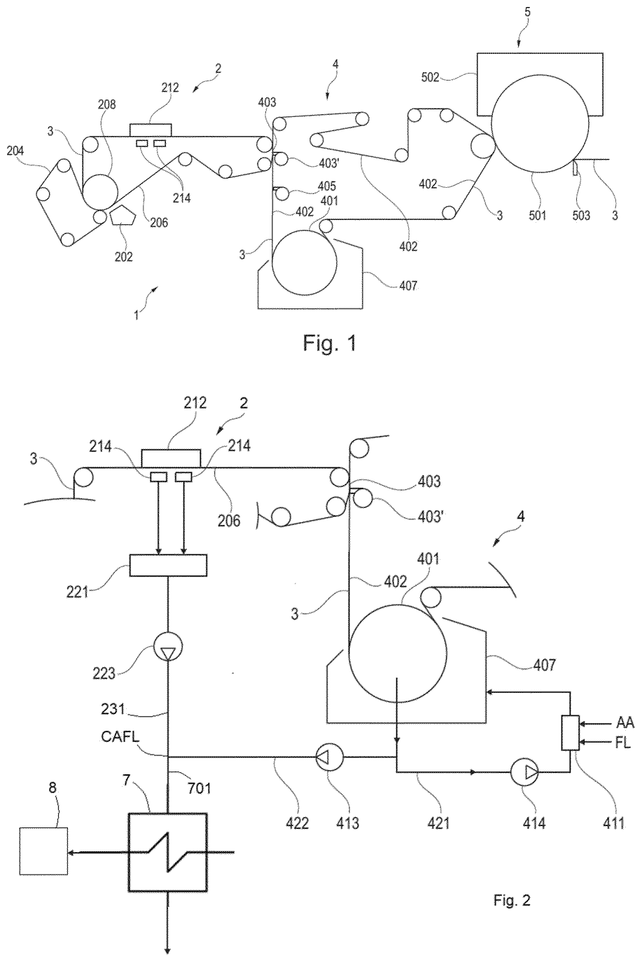

FIG. 1 shows a machine 1 for producing a fibrous web. The fibrous web produced by the machine may be for example used for paper tissue, such as cloth or towel.

The machine comprises a plurality of sections 2, 4, 5 adapted to provide respective steps of the web production. The machine is adapted to sequentially pass material for the fibrous web 3 through the sections. As exemplified below, each section comprises at least one carrier 206, 402, 501 for the web 3, e.g. in the form of a fabric. The carrier(s) of any section is preferably different from the carrier(s) of any other section.

The machine comprises a forming section 2 adapted to form a web 3 from a furnish. A first forming fabric 204 and a second forming fabric 206 partly encircles a forming roll 208. The furnish is introduced through a headbox 202. The furnish is introduced between the first forming fabric 204 and the second forming fabric 206. After passing the forming roll 208, the first forming fabric 204 and the second forming fabric 206 diverge. The second forming fabric 206 and the web 3 pass through a dewatering region 212, described below. Thus, the second forming fabric 206 forms a carrier of the web 3 in the forming section 2.

The machine further comprises a through air drying section 4. Through air drying is usually abbreviated TAD. The TAD section 4 comprises a TAD cylinder 401. The TAD cylinder has a peripheral structure having a plurality of openings. The openings of the peripheral structure may extend in the radial direction of the TAD cylinder. The peripheral structure of the TAD cylinder may be of a honeycomb design. The TAD section 4 further comprises a TAD fabric 402. The TAD fabric 402 forms by means of a plurality of rollers an endless loop which partially extends around the TAD cylinder 401.

The machine is arranged to transfer the web 3 from the forming section 2 to the TAD fabric 402. More specifically, the machine is arranged to transfer the web 3 from the second forming fabric 206 to the TAD fabric 402. Thereby the web 3 is brought in contact with the TAD fabric 402. The transfer station 403 may comprise a shoe (not shown) that presses the TAD fabric 402 against the second forming fabric 206. The transfer station 403 may comprise a suction box 403′ to separate the web 3 from the second forming fabric 206. In some embodiments, the transfer station 403 comprises a vacuum shoe that applies a sub-atmospheric pressure to assist in the transfer of the web 3 to the TAD fabric 402.

Thus, the TAD fabric 402 forms a carrier of the web 3 in the TAD section 4.

The TAD cylinder 401 is partly surrounded by a TAD hood 407. The machine is arranged to establish a pressure difference externally and internally of the TAD cylinder 401, so that air is drawn through the web 3, the TAD fabric 402, and the peripheral structure of the TAD cylinder 401. Thus, air is drawn into the TAD cylinder 401. The pressure difference is provided by a TAD air system, e.g. as the one exemplified below. A sub-atmospheric pressure is established within the TAD cylinder 401 by one or more circulation fans in the TAD air system. The air is heated before it is supplied to the TAD hood 407. From inside the TAD hood 407 the air is drawn through the web 3, the TAD fabric 402, and the peripheral structure of the TAD cylinder 401. Thereby, the air comes in contact with water in the web 3, and moisture is transferred from the web to the air.

The machine further comprises a yankee dryer section 5. The machine is arranged to transfer the web from the TAD section 4 to the yankee dryer section 5. In the yankee dryer section 5 the web 3 is further dried when being passed around a yankee drum 501. The yankee drum 501 is partly surrounded by a yankee hood 502. The web is doctored off the yankee drum 501 by doctor blade 503 and is taken up by a reel (not shown).

Thus, the yankee drum 501 forms a carrier of the web 3 in the yankee dryer section 5.

The TAD section and the yankee dryer section 5 form together what is herein referred to as a drying section 4, 5 adapted to subject the web formed by the forming section 2 to a drying process in order to dry the web formed by the forming section.

Reference is made also to FIG. 2. In the dewatering region 212 of the forming section 2, suction boxes 214 and an air moving arrangement 223 remove moisture from the web 3. The air moving arrangement 223 has an inlet and an exhaust. The air moving arrangement 223 could be in the form of a vacuum blower. The air moving arrangement 223 is arranged to provide a pressure gradient across the web 3 being formed in the forming section in order to move air through the web in order to remove water from the web. The air may be heated by compression by the air moving arrangement.

A stream of air from the exhaust of the air moving arrangement 223 forms a first stream of exhaust air.

A TAD air system circulates the air from the interior of the TAD cylinder 401 via a TAD circulation conduit 421. The air from the interior of the TAD cylinder 401 forms TAD exhaust air. The circulation is provided by means of a circulation fan 414 in the TAD circulation conduit 421. The air is heated by a burner 411 fed by added air AA and fuel FL, such a natural gas. The heated air is fed to the TAD hood 407.

The machine is arranged to guide some of the TAD exhaust air to form a second stream of exhaust air. For this, some of the air from the TAD cylinder 401 is guided through a drying exhaust conduit, in this example a TAD exhaust conduit 422. An exhaust fan 413 is provided in the TAD exhaust conduit 422.

The machine is arranged to guide, by means of one or more forming exhaust conduits 231, the stream of air from the exhaust of the air moving arrangement 223, i.e. the first stream of exhaust air, into the TAD exhaust conduit 422, downstream of the drying exhaust fan 413.

Thereby, the machine is adapted to form a stream of combined air by combining the first and second streams of exhaust air. The machine is further adapted to guide the stream of combined air to a combined air heat exchanger 7. For combining the exhaust streams the forming exhaust conduit 231 joined with the drying exhaust conduit 422 to form a combined air conduit 701. The combined air conduit 701 is arranged to guide the combined air from a location CAFL where the stream of combined air is formed, to the combined air heat exchanger 7. Advantageously, the length of the combined air conduit is at least 2.0 times the hydraulic diameter of the combined air conduit 701.

The combined air heat exchanger 7 is adapted to transfer heat from the combined air to a fluid.

The combined air heat exchanger 7 may be an air-to-liquid heat exchanger. Alternatively, the combined air heat exchanger 7 is an air-to-air heat exchanger. The machine may be arranged to deliver the fluid to which heat from the stream of combined air has been transferred, to a heating system 8 which is separate from the machine.

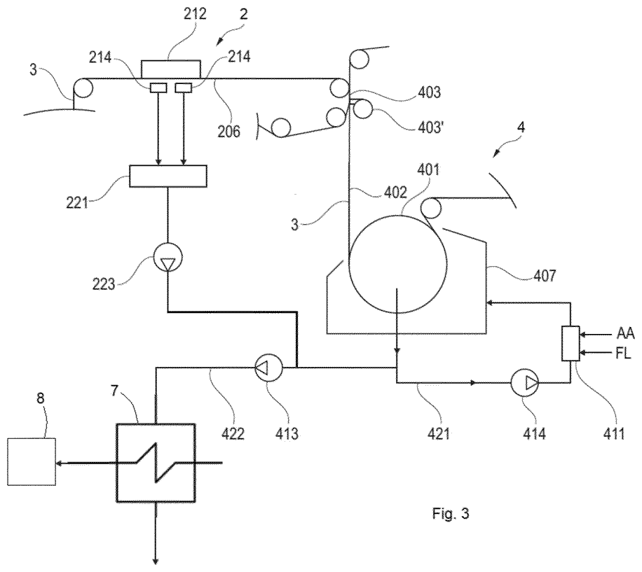

Reference is made to FIG. 3, showing an embodiment which is similar to the one described with reference to FIG. 1 and FIG. 2, except for the following difference: The machine is arranged guide the stream of air from the exhaust of the air moving arrangement 223 into the TAD exhaust conduit 422, upstream of the drying exhaust fan 413.

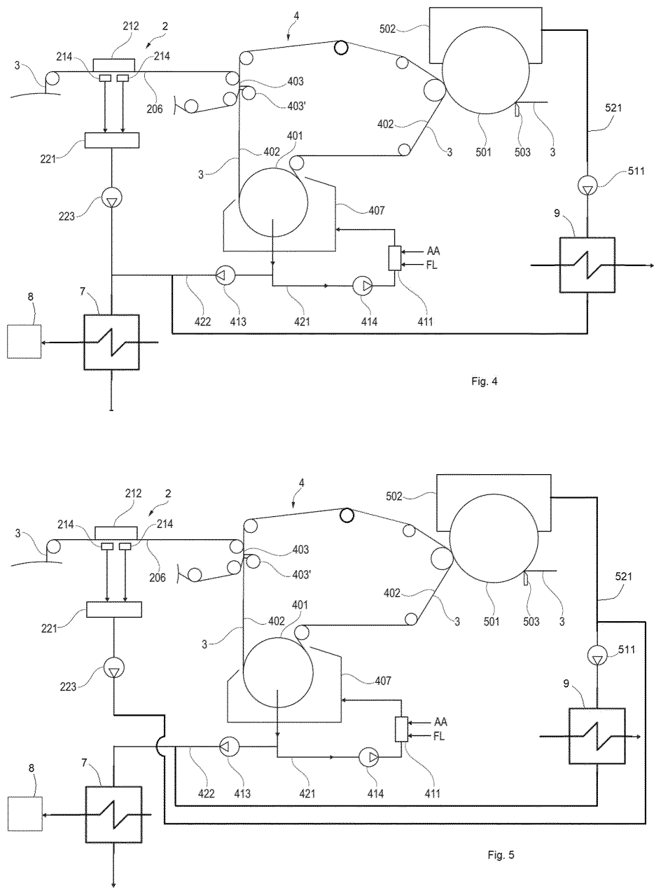

Reference is made to FIG. 4, showing an embodiment which is similar to the one described with reference to FIG. 1 and FIG. 2, except for the following differences:

The machine is arranged to form a yankee hood exhaust stream from the hood 502 of the yankee dryer section 5. For this the machine comprises a yankee exhaust conduit 521 extending from the hood 502. A yankee exhaust fan 511 is provided in the yankee exhaust conduit 521.

The machine is arranged to guide the yankee hood exhaust stream to a yankee heat exchanger 9. Thereby, some of the heat in the yankee hood exhaust stream can be transferred to another fluid stream, e.g. for heat recovery. Also thereby, the temperature of the yankee hood exhaust stream can be reduced.

The machine is further arranged to guide the yankee hood exhaust stream from the yankee heat exchanger 9 to form a part of the second stream. For this, the yankee exhaust conduit 521 extends to the TAD exhaust conduit 422. Thereby, the yankee hood exhaust stream is combined with the TAD exhaust stream.

Further, the machine is adapted to form a stream of combined air by combining the air moving arrangement exhaust stream and the combined yankee hood and TAD exhaust streams. The machine is further adapted to guide the stream of combined air to the combined air heat exchanger 7.

Reference is made to FIG. 5, showing a further embodiment, similar to the one shown in FIG. 4, except for the following difference: The machine is adapted to guide the exhaust of the air moving arrangement 223 to be combined with the yankee hood exhaust stream. The air moving arrangement exhaust is combined with the yankee hood exhaust stream upstream of the yankee heat exchanger 9. Further, the air moving arrangement exhaust is combined with the yankee hood exhaust stream upstream of the yankee exhaust fan 511.

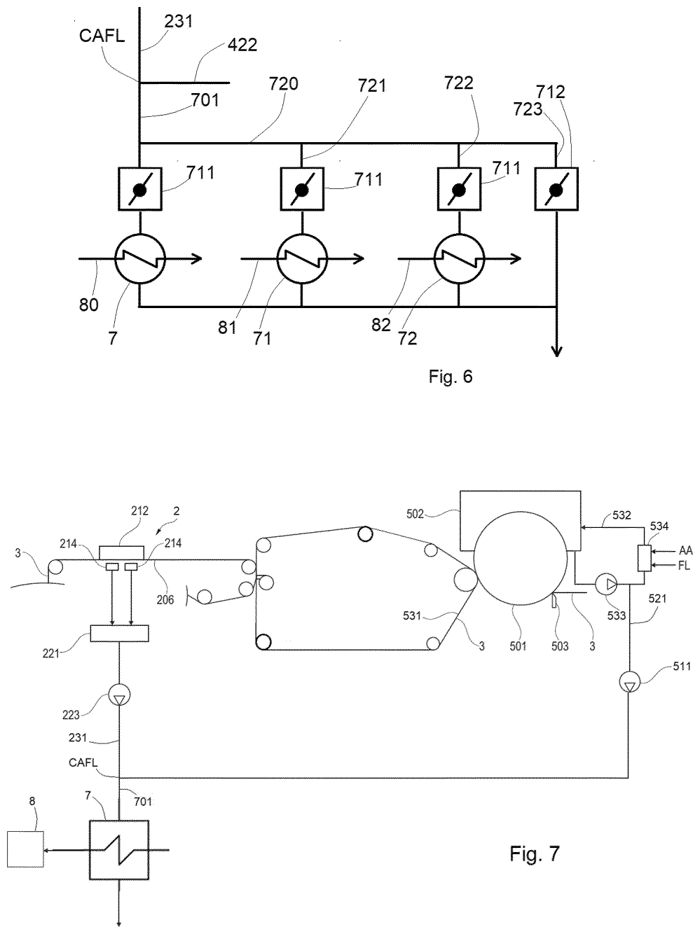

Reference is made to FIG. 6, showing a part of a machine according to yet another embodiment of the invention. First, second, third heat exchangers 7, 71, 72 are arranged in parallel with each other. A forming exhaust conduit 231 leading from a forming section (not shown) is joined with a drying exhaust conduit 422 leading from a drying section (not shown), to form a combined air conduit 701. The combined air conduit 701 is arranged to guide the combined air from a location CAFL, where a stream of combined air is formed, to the first heat exchanger 7. Branch conduits 721, 722 are arranged to guide at least portions of the combined air to the second and third heat exchangers 71, 72. A branch line 720 connects the combined air conduit 701 with the branch conduits 721, 722. Each heat exchanger is adapted to transfer heat to a respective heat receiving fluid 80, 81, 82, e.g. water.

The machine is adapted to selectively guide the stream of combined air to the first heat exchanger 7 or the second heat exchanger 71, 72. The selectivity is provided with dampers 711 in the combined air conduit 701 and the branch conduits 721, 722. Thereby, by suitable control of the dampers, the stream of combined air can be selectively guided to one or more of the heat exchangers. There is also a bypass conduit 723 with a bypass damper 712, for the combined air to bypass the heat exchangers. The branch line 720 connects the combined air conduit 701 with the bypass conduit 723.

The combined air conduit 701 may have a smaller cross-sectional area downstream of the branch line 720 than upstream of the branch line 720. Preferably, the length of the combined air conduit 701 is at least 2.0 times the hydraulic diameter of the combined air conduit downstream of the branch line 720.

Advantages with the embodiment shown in FIG. 6 is understood from the description above.

Reference is made to FIG. 7, showing a part of a machine according to a further embodiment of the invention. As in embodiments described above, the machine comprises a forming section 2, and a stream of air from an exhaust of an air moving arrangement 223 of the forming section forms a first stream of exhaust air.

The machine further comprises a yankee dryer section 5. The machine in FIG. 7 does not comprise a TAD section. The machine comprises a transfer fabric 531 to transfer the web 3 from the forming section 2 to the yankee dryer section 5. The transfer fabric forms by means of a plurality of rollers an endless loop. The machine is arranged to transfer the web 3 from the second forming fabric 206 to the transfer fabric 531, and from the transfer fabric 531 to the yankee dryer section 5. In the yankee dryer section 5 the web 3 is passed around a yankee drum 501 which is partly surrounded by a yankee hood 502 before the web is doctored off the yankee drum 501 by doctor blade 503 and is taken up by a reel (not shown).

A yankee air system circulates air from the yankee hood 502 via a yankee circulation conduit 532. The air from the yankee hood 502 forms yankee circulation air. The circulation is provided by means of a circulation fan 533 in yankee circulation conduit 421. The air is heated by a burner 534 fed by added air AA and fuel FL. The heated air is fed to the yankee hood 502.

The machine is arranged to guide some of the yankee circulation air to form a second stream of exhaust air. For this, some of the air from the yankee hood 502 is guided through a drying exhaust conduit, in this example a yankee exhaust conduit 521. A yankee exhaust fan 511 is provided in the yankee exhaust conduit 521.

The machine is arranged to guide, by means of one or more forming exhaust conduits 231, the stream of air from the exhaust of the air moving arrangement 223, i.e. the first stream of exhaust air, into the yankee exhaust conduit 521. In this embodiment, the first stream of exhaust air is guided into the yankee exhaust conduit 521 downstream of the yankee exhaust fan 511. Thereby, the first and second streams of exhaust air are combined at a combined air forming location CAFL. The machine is further adapted to guide the stream of combined air to a combined air heat exchanger 7.

1-16. (canceled)

17. A machine (1) for producing a fibrous web, such as for tissue, for example paper tissue, the machine comprising:
a plurality of sections (2, 4, 5) adapted to provide respective steps of the web production, the machine being adapted to sequentially pass material for the fibrous web (3) through the sections, the machine being adapted to provide two or more exhaust streams from respective ones of the sections, the machine being adapted to form a stream of combined air by combining two or more exhaust streams of the exhaust streams, and to guide the stream of combined air to a combined air heat exchanger (7) adapted to transfer heat from the combined air to a fluid,
wherein the plurality of sections (2, 4, 5) comprises a forming section (2) adapted to form the web (3) from a furnish, the forming section comprising an air moving arrangement (223), with an inlet and an exhaust, arranged to provide a pressure gradient across the web being formed in the forming section in order to move air through the web being formed in order to remove water from the web being formed, wherein the two or more exhaust streams that the machine is adapted to combine to form the stream of combined air comprises a stream of air from the exhaust of the air moving arrangement, and
wherein the plurality of sections (2, 4, 5) comprises a drying section (4, 5) adapted to subject the web formed by the forming section (2) to a drying process in order to dry the web formed by the forming section, wherein the two or more exhaust streams that the machine is adapted to combine to form the stream of combined air comprises a stream of air with residual heat from the drying process.

18. The machine according to claim 17, wherein the machine is arranged to guide the stream of air with residual heat from the drying process through a drying exhaust conduit (422) to the combined air heat exchanger (7), wherein a drying exhaust fan (413) is provided in the drying exhaust conduit (422), wherein the machine is arranged to guide the stream of air from the exhaust of the air moving arrangement (223) into the drying exhaust conduit (422), downstream of the drying exhaust fan (413).

19. The machine according to claim 17, wherein the machine is arranged to guide the stream of air with residual heat from the drying process through a drying exhaust conduit (422) to the combined air heat exchanger (7), wherein a drying exhaust fan (413) is provided in the drying exhaust conduit (422), wherein the machine is arranged guide the stream of air from the exhaust of the air moving arrangement (223) into the drying exhaust conduit (422), upstream of the drying exhaust fan (413).

20. The machine according to claim 17, wherein the drying section comprises a through air drying (TAD) section (4), comprising a TAD cylinder (401) with a peripheral structure having a plurality of openings, wherein the TAD section further comprises a TAD fabric (402) forming by means of a plurality of rollers an endless loop which partially extends around the TAD cylinder (401), wherein the TAD section (4) is arranged to establish a pressure difference externally and internally of the TAD cylinder (401), so that air is drawn through the web (3), the TAD fabric (402), and the peripheral structure of the TAD cylinder (401) to form a stream of TAD exhaust air, wherein the machine is arranged to guide at least some of the TAD exhaust air in the stream of TAD exhaust air to form one of the two or more exhaust streams that the machine is adapted to combine to form the stream of combined air.

21. The machine according to claim 17, wherein the drying section comprises a yankee dryer section (5) comprising a yankee dryer (501, 502), wherein the two or more exhaust streams that the machine is adapted to combine to form the stream of combined air comprises a yankee hood exhaust stream from a hood (502) of the yankee dryer.

22. The machine according to claim 21, wherein the machine is arranged to guide air in the yankee hood exhaust stream to a yankee heat exchanger (9), and to guide the air in the yankee hood exhaust stream from the yankee heat exchanger to form a part of the combined airstream.

23. The machine according to claim 17, wherein the combined air heat exchanger (7) is an air-to-liquid heat exchanger.

24. The machine according to claim 17, wherein the combined air heat exchanger (7) is an air-to-air heat exchanger.

25. The machine according to claim 17, wherein the machine is arranged to deliver the fluid to which heat from the stream of combined air has been transferred, to a heating system (8) which is separate from the machine.

26. The machine according to claim 17, wherein the combined air heat exchanger (7) is a first heat exchanger and the fluid is a first fluid, wherein the machine comprises a second heat exchanger (72, 73) arranged in parallel with the first heat exchanger and adapted to receive at least a portion of the stream of combined air and to transfer heat from the combined air to a second fluid.

27. The machine according to claim 26, wherein the machine is adapted to selectively guide the stream of combined air to the first heat exchanger (7) or the second heat exchanger (72, 73).

28. The machine according to claim 17, wherein the machine comprises a combined air conduit (701) arranged to guide the combined air from a location (CAFL) where the stream of combined air is formed, to the combined air heat exchanger (7), wherein the length of the combined air conduit is at least 1.0 times the hydraulic diameter of the combined air conduit or a part of the combined air conduit with the smallest cross-sectional area.

29. The machine according to claim 28, wherein the length of the combined air conduit is at least 1.5 times the hydraulic diameter of the combined air conduit or a part of the combined air conduit with the smallest cross-sectional area.

30. The machine according to claim 28, wherein the length of the combined air conduit is at least 2.0 times the hydraulic diameter of the combined air conduit or a part of the combined air conduit with the smallest cross-sectional area.

31. The machine according to claim 17, wherein no heat exchanger is provided in a combined air conduit (701) arranged to guide the combined air from a location (CAFL) where the stream of combined air is formed, to the combined air heat exchanger (7).

32. A machine (1) for producing a fibrous web, such as for tissue, for example paper tissue, the machine comprising:
a plurality of sections (2, 4, 5) adapted to provide respective steps of the web production, the machine being adapted to sequentially pass material for the fibrous web (3) through the sections, the machine being adapted to provide two or more exhaust streams from respective ones of the sections, the machine being adapted to form a stream of combined air by combining two or more exhaust streams of the exhaust streams, and to guide the stream of combined air to a combined air heat exchanger (7) adapted to transfer heat from the combined air to a fluid,
wherein the machine comprises a combined air conduit (701) arranged to guide the combined air from a location (CAFL) where the stream of combined air is formed, to the combined air heat exchanger (7), wherein said extension of the combined air conduit is at least 1.0 times the hydraulic diameter of the combined air conduit or a part of the combined air conduit with the smallest cross-sectional area.

33. The machine according to claim 32, wherein the length of the combined air conduit is at least 1.5 times the hydraulic diameter of the combined air conduit or a part of the combined air conduit with the smallest cross-sectional area.

33. The machine according to claim 32, wherein the length of the combined air conduit is at least 2.0 times the hydraulic diameter of the combined air conduit or a part of the combined air conduit with the smallest cross-sectional area.

34. A machine (1) for producing a fibrous web, such as for tissue, for example paper tissue, the machine comprising:
a plurality of sections (2, 4, 5) adapted to provide respective steps of the web production, the machine being adapted to sequentially pass material for the fibrous web (3) through the sections, the machine being adapted to provide two or more exhaust streams from respective ones of the sections, the machine being adapted to form a stream of combined air by combining two or more exhaust streams of the exhaust streams, and to guide the stream of combined air to a combined air heat exchanger (7) adapted to transfer heat from the combined air to a fluid,
wherein no heat exchanger is provided in a combined air conduit (701) arranged to guide the combined air from a location (CAFL) where the stream of combined air is formed, to the combined air heat exchanger (7).

35. A combined air heat exchanger (7) for the machine according to claim 17, wherein the combined air heat exchanger (7) is adapted to receive the stream of combined air, and to transfer heat from the combined air to a fluid.
